(19) United States
(12) Patent Application Publication
(10) Pub. No.: US 2024/0264735 A1
(43) Pub. Date: Aug. 8, 2024

(54) ADAPTIVE TOUCHPAD FOR USE WITH EXTERNAL DISPLAY

(71) Applicant: Dell Products L.P., Round Rock, TX (US)

(72) Inventors: Po-Han LIN, Taipei City (TW); Chin-Yuan CHIANG, Sanchong Dist. (TW); Chien-Cheng CHIU, New Taipei City (TW)

(73) Assignee: Dell Products L.P., Round Rock, TX (US)

(21) Appl. No.: 18/164,900

(22) Filed: Feb. 6, 2023

(51) Int. Cl. G06F 3/0488

(52) U.S. Cl. CPC G06F 3/0488

(57) ABSTRACT

An information handling system may include a processor, a touchpad communicatively coupled to the processor, and non-transitory computer-readable media communicatively coupled to the processor and having stored thereon a program of instructions configured to, when read and executed by the processor, determine a display from a plurality of displays of the information handling system upon which is displayed a visual object being manipulated by user interaction with the touchpad and based on the display determined, apply a display-based function defining movement of the visual object in response to user interaction with the touchpad.

### TECHNICAL FIELD

The present disclosure relates in general to information handling systems, and more particularly to a touchpad for use in an information handling system, wherein the information handling system is configured to apply a different ballistic curve for the touchpad for different display devices of the information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems utilize a touchpad. A touchpad may comprise a pointing device that includes a tactile sensor that may translate motion and position of a user's fingers (or other pointing device, such as a stylus) to a relative position on a display device of an information handling system.

Increasingly, users of information handling systems prefer to use external displays, in addition to the integrated display of a notepad/laptop, for multiple tasks. However, when using a touchpad with both an integrated display and external display, moving a cursor and other objects (e.g., such as when doing a “drag-n-drop” of a file icon or other object) may be more difficult (e.g., may take multiple user swipes across the touchpad) when the external display is of a significantly high display resolution.

### SUMMARY

In accordance with the teachings of the present disclosure, the disadvantages and problems associated with use of a touchpad with multiple display devices may be reduced or eliminated.

In accordance with embodiments of the present disclosure, an information handling system may include a processor, a touchpad communicatively coupled to the processor, and non-transitory computer-readable media communicatively coupled to the processor and having stored thereon a program of instructions configured to, when read and executed by the processor, determine a display from a plurality of displays of the information handling system upon which is displayed a visual object being manipulated by user interaction with the touchpad and based on the display determined, apply a display-based function defining movement of the visual object in response to user interaction with the touchpad.

In accordance with these and other embodiments of the present disclosure, a method may include determining a display from a plurality of displays of an information handling system upon which is displayed a visual object being manipulated by user interaction with a touchpad of the information handling system and based on the display determined, apply a display-based function defining movement of the visual object in response to user interaction with the touchpad.

In accordance with these and other embodiments of the present disclosure, an article of manufacture may include a non-transitory computer readable medium and computer-executable instructions carried on the computer readable medium, the instructions readable by a processing device, the instructions, when read and executed, for causing the processing device to, determine a display from a plurality of displays of an information handling system upon which is displayed a visual object being manipulated by user interaction with a touchpad and based on the display determined, apply a display-based function defining movement of the visual object in response to user interaction with the touchpad.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a perspective view of an example information handling system, in accordance with embodiments of the present disclosure;

FIG. 2 illustrates an external display communicatively coupled to an information handling system, in accordance with embodiments of the present disclosure;

FIG. 3 illustrates a functional block diagram of an example information handling system, in accordance with embodiments of the present disclosure;

FIG. 4 illustrates example ballistic curves, in accordance with embodiments of the present disclosure; and

FIG. 5 illustrates a flow chart of an example method for adapting a ballistic curve to multiple displays, in accordance with embodiments of the present disclosure.

### DETAILED DESCRIPTION

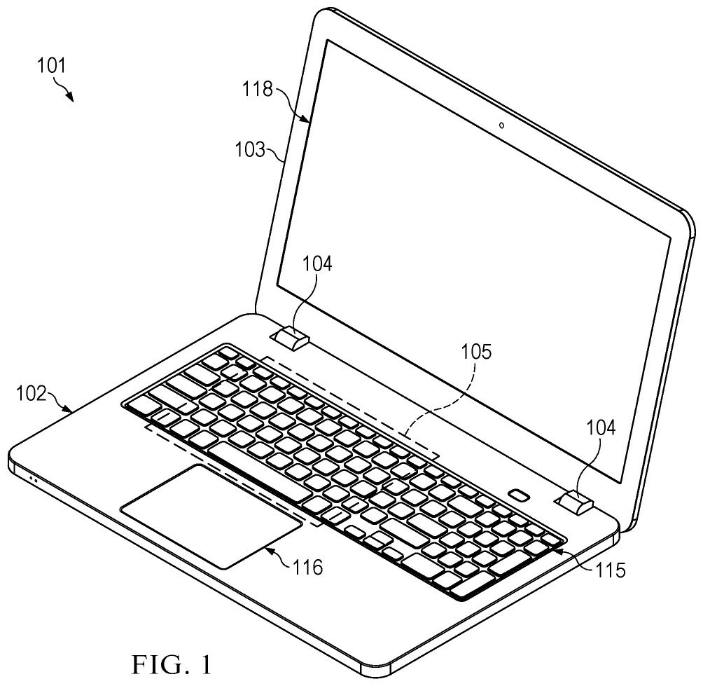

Preferred embodiments and their advantages are best understood by reference to FIGS. 1 through 5, wherein like numbers are used to indicate like and corresponding parts. For the purposes of this disclosure, an information handling system may include any instrumentality or aggregate of instrumentalities operable to compute, classify, process, transmit, receive, originate, retrieve, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a perspective view of an example information handling system 101, in accordance with embodiments of the present disclosure. As depicted in FIG. 1, information handling system 101 may comprise a notebook or “laptop” computer. In other embodiments, information handling system 101 may comprise a mobile device sized and shaped to be readily transported and carried on a person of a user of information handling system 101 (e.g., a smartphone, a tablet computing device, a handheld computing device, a personal digital assistant, etc.). As illustrated in FIG. 1, information handling system 101 may comprise a first housing 102, a second housing 103 and one or more hinges 104. First housing 102 may comprise, for example, a main body housing. Accordingly, in some embodiments, a circuit board 105 and other information handling resources may be housed within first housing 102. Circuit board 105 may include one or more information handling resources, including without limitation, one or more processors, one or more memories, and/or one or more peripheral devices.

As also shown in FIG. 1, first housing 102 may include keyboard 115 and a touchpad 116. Keyboard 115 and touchpad 116 may each comprise input devices for receiving input from a user to allow the user to control operation of information handling system 101. In some embodiments, information handling system 101 may comprise other input devices in addition to or instead of keyboard 115 and/or touchpad 116.

As illustrated in FIG. 1, second housing 103 may include a display housing and may comprise a display 118 (e.g., a display device or a display module) communicatively coupled to circuit board 105.

Hinge (s) 104 may rotatably couple first housing 102 to second housing 103. Thus, information handling system 101 may be openable and closable (i.e., foldable). In other words, information handling system 101 may be transformable between a first state in which first housing 102 and second housing 103 overlap each other, and a second state in which first housing 102 and second housing 103 are opened and keyboard 115, touchpad 116, and display 118 are exposed to the outside.

Touchpad 116 may comprise an input device having the function of a pointing device and a push button. That is, touchpad 116 may associate a movement of a finger, stylus, or other pointing device tracing the surface of touchpad 116 with the movement of a mouse pointer on a screen of display 118.

The information handling system to which a touchpad 116 as described herein can be applied is not limited to the above example of a notebook information handling system having two hinged housings, and may be broadly applied to various types of electronic apparatuses such as a tablet terminal, a television, a cellular phone (including a smartphone), a game console, and/or other information handling systems that include a single housing. In one or more of such devices, a touchscreen may effectively include the functionality of a touchpad and a display.

Although not explicitly shown in FIG. 1, information handling system 101 may include a clicking device (e.g., button or mechanism integrated within touchpad 116) to perform the same function as clicking on a button of a mouse or other device.

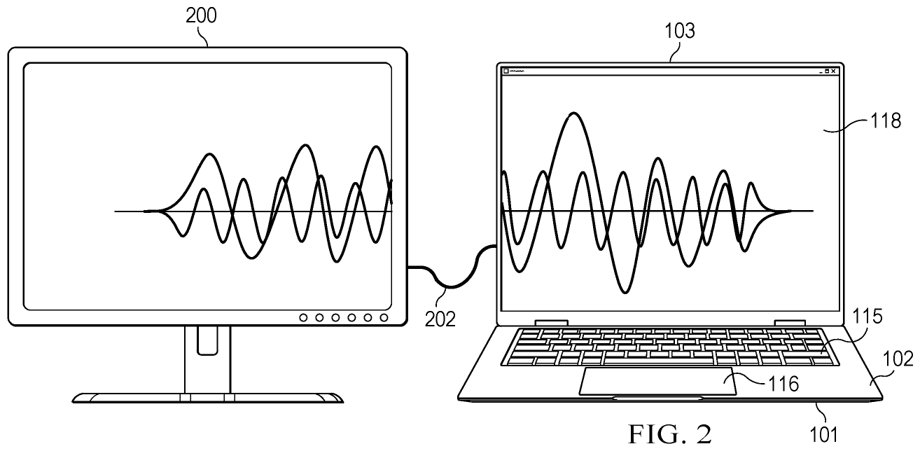

FIG. 2 illustrates an external display 200 communicatively coupled to information handling system 101 via a cable 202, in accordance with embodiments of the present disclosure. Accordingly, a user interfacing with information handling system 101 via input devices (e.g., keyboard 115, touchpad 116) may manipulate text, images, and/or other objects on external display 200.

Although external display 200 is depicted as being coupled via a wired connection using cable 202, in some embodiments, both information handling system 101 and external display 200 may be enabled to communicatively couple via wireless transmission (e.g., Bluetooth).

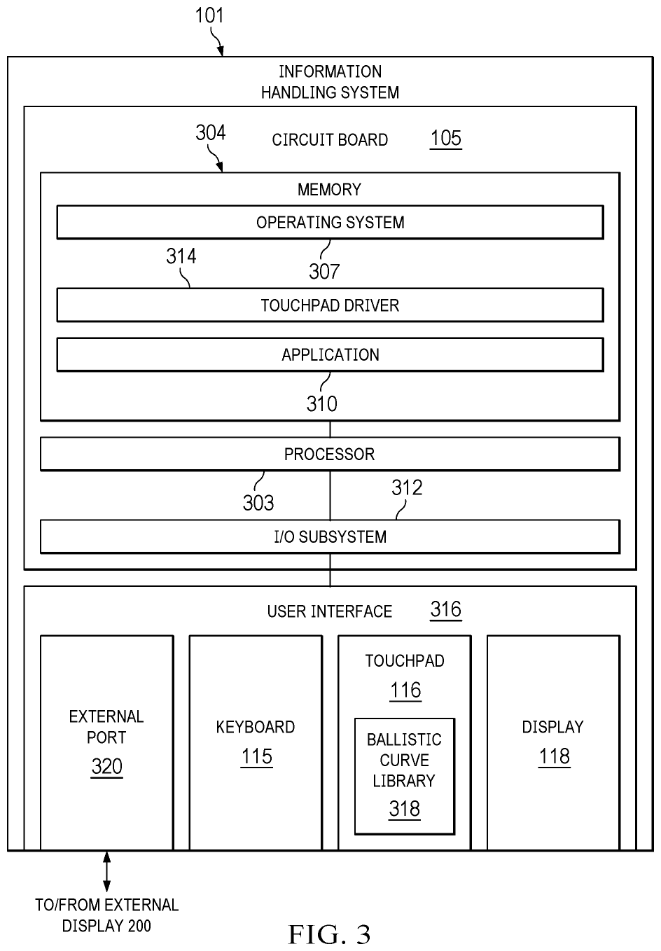

FIG. 3 illustrates a functional block diagram of an example information handling system 101, in accordance with embodiments of the present disclosure. As depicted in FIG. 3, information handling system 101 may include a processor 303, a memory 304 communicatively coupled to processor 303, an input/output (I/O) subsystem 312 communicatively coupled to processor 303, and a user interface 316 communicatively coupled to I/O subsystem 312.

Processor 303 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 303 may interpret and/or execute program instructions and/or process data stored in memory 304 and/or another component of information handling system 101.

Memory 304 may be communicatively coupled to processor 303 and may include any system, device, or apparatus configured to retain program instructions and/or data for a period of time (e.g., computer-readable media). Memory 304 may include RAM, EEPROM, a PCMCIA card, flash memory, magnetic storage, opto-magnetic storage, or any suitable selection and/or array of volatile or non-volatile memory that retains data after power to information handling system 101 is turned off. As shown in FIG. 3, memory 304 may have stored thereon an operating system 307, a touchpad driver 314, and an application 310.

Operating system 307 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by host operating system 307. Active portions of operating system 307 may be read from memory 304 for execution by processor 303.

Touchpad driver 314 may comprise any program of executable instructions, or aggregation of programs of executable instructions, configured to provide a software interface to touchpad driver 314, in order to enable operating system 307 and/or application 310 to access hardware functions of touchpad 116.

Application 310 may comprise any program of executable instructions, or aggregation of programs of executable instructions, configured to carry out a specific task other than one relating to the operation of the computer itself. Such application may comprise a productivity application (e.g., word processor, spreadsheet application, image editing application), a game, or any other suitable application.

I/O subsystem 312 may comprise any suitable system, device, or apparatus generally operable to receive and transmit data to or from or within information handling system 101. I/O subsystem 312 may represent, for example, any one or more of a variety of communication interfaces, graphics interfaces, video interfaces, user input interfaces, and peripheral interfaces.

User interface 316 may comprise any instrumentality or aggregation of instrumentalities by which a user may interact with information handling system 101. For example, user interface 316 may permit a user to input data and/or instructions into information handling system 101 (e.g., via a keyboard 115, a touchpad 116, and/or other suitable component), and/or otherwise manipulate information handling system 101 and its associated components. User interface 316 may also permit information handling system 101 to communicate data to a user, e.g., by way of a display 118 and/or external display 200 coupled to external port 320 of user interface 316.

As also shown in FIG. 3, touchpad 116 may include (e.g., may have stored thereon within firmware of touchpad 116), a ballistic curve library 318. Ballistic curve library 318 may comprise a database, library, table, map, or other suitable data structure configured to store ballistic curve functions for display 118 and one or more external displays (e.g., external display 200) that may be coupled to information handling system 101. As is known is the art, a ballistic curve may define a distance by which a cursor or other object appearing on a display device moves as a function of a speed of movement of a user's finger, stylus, or other interaction with touchpad 116.

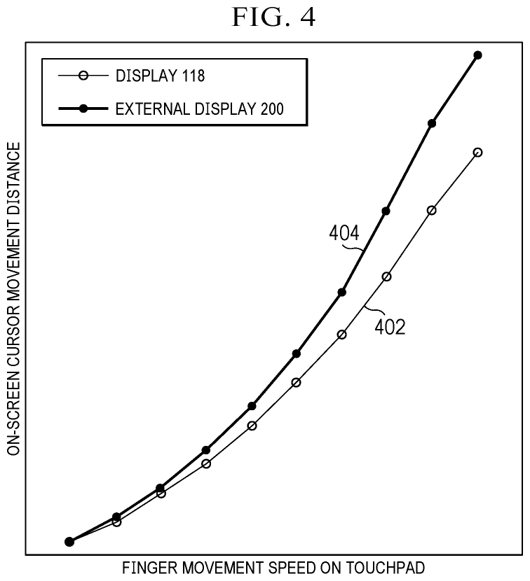

In operation, touchpad driver 314 may be configured to detect if an external display (e.g., external display 200) is coupled to information handling system 101 (e.g., via external port 320). Further, with an external display coupled to information handling system 101, touchpad driver 314 may be configured to detect upon a particular display an appearance of a cursor or other visual object that may be manipulated by touchpad 116 and apply a ballistic curve to such visual object based on which display such visual object appears such that the visual object moves on such display in accordance with such display-based ballistic curve. For example, FIG. 4 illustrates a first ballistic curve 402, which may be based on a size and resolution of display 118, that touchpad driver 314 may apply to a distance of movement of a visual object across display 118 as a function of a speed of interaction of an object (e.g., user finger or stylus) with touchpad 116 and a second ballistic curve 404, which may be based on a size and resolution of external display 200, that touchpad driver 314 may apply to a distance of movement of a visual object across external display 200 as a function of a speed of interaction of an object (e.g., user finger or stylus) with touchpad 116.

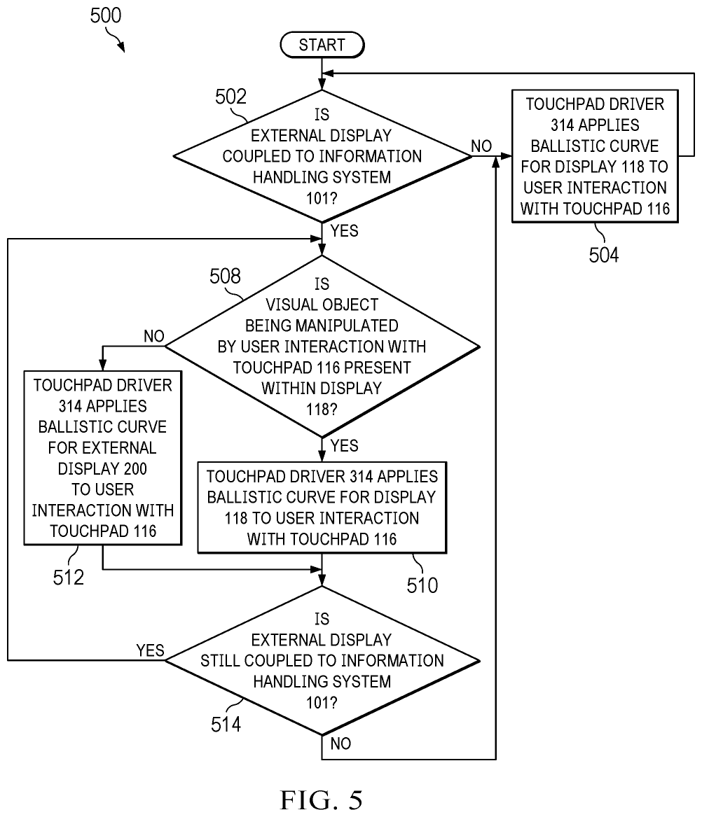

FIG. 5 illustrates a flow chart of an example method 500 for adapting a ballistic curve to multiple displays, in accordance with embodiments of the present disclosure. According to some embodiments, method 500 may begin at step 502. As noted above, teachings of the present disclosure may be implemented in a variety of configurations of information handling system 101. As such, the preferred initialization point for method 500 and the order of the steps comprising method 500 may depend on the implementation chosen.

At step 502, touchpad driver 314 may determine if an external display is coupled to information handling system 101. If an external display 200 is coupled to information handling system 101, method 500 may proceed to step 508. Otherwise, method 500 may proceed to step 504.

At step 504, if no external display 200 is coupled to information handling system 101, touchpad driver 314 may simply apply a ballistic curve for display 118 (e.g., ballistic curve 402) to user interaction with touchpad 116. For example, touchpad driver 314 may communicate a command to touchpad 116 to apply ballistic curve 402 to user interactions with touchpad 116. After completion of step 504, method 500 may proceed again to step 502.

As step 508, if external display 200 is coupled to information handling system 101, touchpad driver 314 may determine whether a visual object (e.g., cursor) being manipulated by user interaction with touchpad 116 is present within display 118 or external display 200. If the visual object is present within display 118, method 500 may proceed to step 510. Otherwise, if the visual object is present within external display 200, method 500 may proceed to step 512.

At step 510, if the visual object is present within display 118, touchpad driver 314 may apply the ballistic curve for display 118 to user interaction with touchpad 116. For example, touchpad driver 314 may communicate a command to touchpad 116 to apply ballistic curve 402 to user interactions with touchpad 116. After completion of step 510, method 500 may proceed to step 514.

At step 512, if the visual object is present within external display 200, touchpad driver 314 may apply the ballistic curve for external display 200 (e.g., ballistic curve 404) to user interaction with touchpad 116, which ballistic curve may be based on a size and resolution of external display 200. For example, touchpad driver 314 may communicate a command to touchpad 116 to apply ballistic curve 404 to user interactions with touchpad 116.

At step 514, touchpad driver 314 may determine whether external display 200 remains coupled to information handling system 101. If external display 200 remains coupled to information handling system 101, method 500 may proceed again to step 508. Otherwise, method 500 may proceed again to step 504.

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Method 500 may be implemented using information handling system 101 or any other system operable to implement method 500. In certain embodiments, method 500 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. An information handling system comprising:
a processor;
a touchpad communicatively coupled to the processor; and
non-transitory computer-readable media communicatively coupled to the processor and having stored thereon a program of instructions configured to, when read and executed by the processor:
determine a display from a plurality of displays of the information handling system upon which is displayed a visual object being manipulated by user interaction with the touchpad, wherein the visual object is configured to move between the determined display and another display from the plurality of displays; and
based on the display determined, apply a display-based function defining movement of the visual object in response to user interaction with the touchpad.

2. The information handling system of claim 1, wherein the display-based function is a ballistic curve associated with the display defining a distance of movement of the object across the display as a function of a speed of movement of the user interaction with the touchpad.

3. The information handling system of claim 1, wherein the display-based function is based on at least one of a size and a resolution of the display.

4. The information handling system of claim 1, wherein the plurality of displays comprises:
a display integrated within the information handling system; and
an external display externally coupled to the information handling system.

5. The information handling system of claim 1, wherein the program of instructions is further configured to perform the determination of the display from the plurality of displays and the application of the display-based function responsive to a determination that an external display is externally coupled to the information handling system.

6. The information handling system of claim 5, wherein the program of instructions is further configured to, in response to the determination that the external display is externally coupled to the information handling system, load a display-based function associated with the external display defining movement of the visual object within the external display in response to user interaction with the touchpad.

7. A method comprising:
determining a display from a plurality of displays of an information handling system upon which is displayed a visual object being manipulated by user interaction with a touchpad of the information handling system, wherein the visual object is configured to move between the determined display and another display from the plurality of displays; and
based on the display determined, apply a display-based function defining movement of the visual object in response to user interaction with the touchpad.

8. The method of claim 7, wherein the display-based function is a ballistic curve associated with the display defining a distance of movement of the object across the display as a function of a speed of movement of the user interaction with the touchpad.

9. The method of claim 7, wherein the display-based function is based on at least one of a size and a resolution of the display.

10. The method of claim 7, wherein the plurality of displays comprises:
a display integrated within the information handling system; and
an external display externally coupled to the information handling system.

11. The method of claim 7, further comprising performing the determining step and the applying step responsive to determining that an external display is externally coupled to the information handling system.

12. The method of claim 11, further comprising, in response to determining that the external display is externally coupled to the information handling system, loading a display-based function associated with the external display defining movement of the visual object within the external display in response to user interaction with the touchpad.

13. An article of manufacture comprising:
a non-transitory computer readable medium; and
computer-executable instructions carried on the computer readable medium, the instructions readable by a processing device, the instructions, when read and executed, for causing the processing device to:
determine a display from a plurality of displays of an information handling system upon which is displayed a visual object being manipulated by user interaction with a touchpad, wherein the visual object is configured to move between the determined display and another display from the plurality of displays; and
based on the display determined, apply a display-based function defining movement of the visual object in response to user interaction with the touchpad.

14. The article of claim 13, wherein the display-based function is a ballistic curve associated with the display defining a distance of movement of the object across the display as a function of a speed of movement of the user interaction with the touchpad.

15. The article of claim 13, wherein the display-based function is based on at least one of a size and a resolution of the display.

16. The article of claim 13, wherein the plurality of displays comprises:
a display integrated within the information handling system; and
an external display externally coupled to the information handling system.

17. The article of claim 13, the instructions for further causing the processing device to perform the determination of the display from the plurality of displays and the application of the display-based function responsive to a determination that an external display is externally coupled to the information handling system.

18. The article of claim 17, the instructions for further causing the processing device to, in response to the determination that the external display is externally coupled to the information handling system, load a display-based function associated with the external display defining movement of the visual object within the external display in response to user interaction with the touchpad.
